(19) United States
(12) Patent Application Publication
(10) Pub. No.: US 2017/0234182 A1
(43) Pub. Date: Aug. 17, 2017

(54) HIGH-END PROCESSING DEVICE FOR PURIFICATION OF EXHAUST OF DIESEL ENGINE

(71) Applicant: Wen-Lo Chen, Taipei City (TW)

(72) Inventor: Wen-Lo Chen, Taipei City (TW)

(21) Appl. No.: 15/045,268

(22) Filed: Feb. 17, 2016

(51) Int. Cl. F01N 3/035; B01D 46/00; B01D 46/24; B01D 53/94; F01N 3/022; F01N 13/00

(52) U.S. Cl. CPC F01N 3/035; F01N 3/0222; F01N 13/0093; F01N 13/011; B01D 46/2403; B01D 53/94; B01D 46/0023; F01N 2250/02; F01N 2570/14; F01N 2330/06; B01D 2267/30; B01D 2267/40

(57) ABSTRACT

A high-end processing device for purification of exhaust of a diesel engine includes a connection channel, a plurality of catalytic converters, a plurality of direct-passage ceramic filters, and at least one wall-flow filter. The catalytic converters are arranged, in a manner of being spaced from each other, at a front portion of an exhaust gas flow path defined by the connection channel. The direct-passage ceramic filters and the wall-flow filter are arranged, in a manner of being spaced from each other, at a rear portion of the exhaust gas flow path of the connection channel. The direct-passage ceramic filters and the wall-flow filter are impregnated with urea or ammonia and dried so as to reduce nitrogen oxides (NOx) into nitrogen and water to reduce impact to the environment.

### (a) TECHNICAL FIELD OF THE INVENTION

The present invention relates generally to a compact catalytic conversion device, and more particularly to a device that effectively and completely purify the exhaust of a diesel engine and clear off carbon deposit.

### (b) DESCRIPTION OF THE PRIOR ART

In addition to carbon particles, the exhaust gas from a diesel engine vehicle also contains nitrogen oxides (NOx) that cause pollution to the environment. Heretofore, a selective catalytic reduction (SCR) device is applied to handle the nitrogen oxides. The selective catalytic reduction system injects urea supplied from an urea container installed in an automobile into combusted exhaust gas to convert the high-temperature exhaust gas into ammonia (NH₃), allowing ammonia to generate a chemical reduction reaction with nitrogen oxides (NOx) in the selective catalytic reduction device for conversion into nitrogen and water that cause no influence to the environment. Such a conversion/reduction operation is carried out with the ratio of diesel to urea being 20:1 (meaning for every 20 parts of diesel, there must be a supply of one part of urea) and this leads to fast consumption of urea and frequent replenishment becomes necessary to maintain a normal operation. This causes troubles in use and consumes a lot of money.

### SUMMARY OF THE INVENTION

The present invention provides a high-end processing device for purification of exhaust of a diesel engine, which comprises a connection channel, a plurality of catalytic converters, a plurality of direct-passage ceramic filters, and at least one wall-flow filter. The catalytic converters are arranged, in a manner of being spaced from each other, at a front portion of an exhaust gas flow path defined by the connection channel. The direct-passage ceramic filters and the wall-flow filter are arranged, in a manner of being spaced from each other, at a rear portion of the exhaust gas flow path of the connection channel. The direct-passage ceramic filters and the wall-flow filter are impregnated with urea or ammonia and dried so as to allow smog exhaust gas containing carbon particles that have not been completely combusted in the engine and the hydrocarbon compounds, when discharged from an exhaust pipe, to be directly combusted and thus purified by the catalytic converters at the front portion, while the remaining toxicant exhaust gas, such as nitrogen oxides (NOx), when passing through the direct-passage ceramic filters and the wall-flow filter at the rear portion, can be reduced by urea and ammonia back into nitrogen and water to reduce influence to the environment.

To technical solution adopted in the present invention a connection channel, which comprises a plurality of chambers mounted thereto, at least one passage connecting between every two adjacent ones of the chambers so as to define an exhaust inlet and an exhaust outlet respectively located at opposite ends thereof; a plurality of catalytic converters, which is respectively arranged in successive ones of the chamber posterior immediately to the exhaust inlet; a plurality of direct-passage ceramic filters, which is respectively arranged in successive ones of the chambers that are posterior to one of the catalytic converters that is remote from the exhaust inlet; at least one wall-flow filter, which is arranged in one of the chambers that is posterior to one of the direct-passage ceramic filters that is remote from the exhaust inlet; wherein the direct-passage ceramic filters and the wall-flow filter are first impregnated in a urea solution or an ammonia solution in advance to allow the urea solution or the ammonia solution to penetrate into pores of the direct-passage ceramic filters and the wall-flow filter and the dried so that the direct-passage ceramic filters and the wall-flow filter provide an effect of reducing nitrogen oxides back into nitrogen and water.

The advantages of the present invention are that with the present invention installed in an automobile, when the automobile is in operation, carbon particles remaining in exhaust gas can be automatically combusted and purified by means of catalytic converters so that there is no need to first capture and thus conduct “filter regeneration” by an electronic control unit (ECU) of the automobile computer. Further, the present invention can maintain operation without frequent replenishment of urea that is required by the prior art devices so that when direct-passage ceramic filters and the wall-flow filter are gradually losing functionality, it only needs to inject urea or aqua ammonia from the exhaust outlet into the direct-passage ceramic filters and the wall-flow filter to be absorbed thereby and penetrating therein, making the use convenient.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a cross-sectional view illustrating an embodiment of the present invention.

FIG. 2 is a cross-sectional view illustrating an embodiment of the present invention.

FIG. 3 is a cross-sectional view illustrating an embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

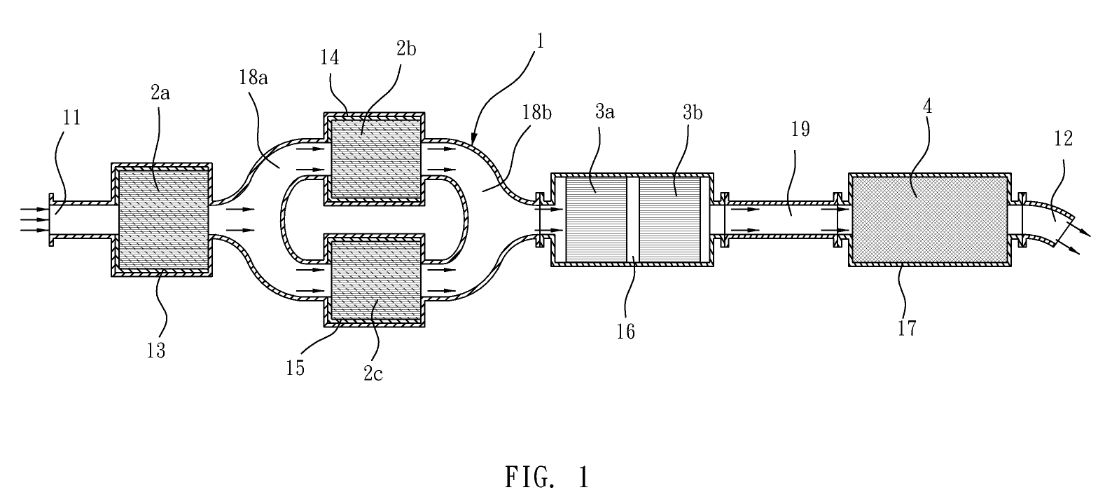

As shown in FIG. 1, the present invention provides a high-end processing device for purification of exhaust of a diesel engine, of which a first embodiment comprises a connection channel 1, which comprises, mounted in sequence thereto, a first chamber 13, a second chamber 14, a third chamber 15, a fourth chamber 16, and a fifth chamber 17, wherein the second chamber 14 and the third chamber 15 are arranged parallel to each other and are connected, in a series manner, to the first chamber 13 by a Y-shaped first split passage 18a and are also connected, in a series manner, to the fourth chamber 16 by a Y-shaped second split passage 18b; the fifth chamber 17 is connected, in a series manner, to the fourth chamber 16 by an elongate passage 19; the first chamber 13 has a leading end connected to an exhaust inlet 11; and the fifth chamber 17 has a tailing end connected to an exhaust outlet 12.

The first, second, and third chambers 13, 14, 15 are respectively provided therein a first catalytic converter 2a, a second catalytic converter 2b, and a third catalytic converter 2c. The fourth chamber 16 is provided therein with a first direct-passage ceramic filter 3a and a second direct-passage ceramic filter 3b that are sequentially arranged in an axial direction. The fifth chamber 17 is provided therein with a wall-flow filter 4. The catalytic converters are used to reduce the amount of toxicant carbon monoxide by 90% and reduce the amount of hydrocarbon compounds by 85% and has a composition that comprises cordierite ceramic formed of extrusion molding, followed by additional processing. Cordierite is an excellent heat-resistant material (having a melting point as up as 1400° C.) and has a thermal expansion coefficient that is close to zero (0) so that it can bear an abrupt change of temperature; in addition, the mechanical strength is increased with the increase of temperature in a high-temperature condition (below 1200° C.).

The first and second direct-passage ceramic filters 3a, 3b and the wall-flow filter 4 are first impregnated in urea solution or ammonia solution to allow the urea solution or ammonia solution to penetrate into pores of the direct-passage ceramic filters and the wall-flow filter and then dried to provide the direct-passage ceramic filters and the wall-flow filter with a function of reduce nitrogen oxides back into nitrogen and water.

The present invention, after being installed in an automobile, is operated such that during a process that exhaust gas discharged from a diesel engine enters, via the exhaust inlet 11 at one end of the connection channel 1, and drains out through the exhaust outlet 12 at an opposite end, the exhaust gas first enters the first chamber 13 and fast passes through the first catalytic converter 2a, and then moves through the first split passage 18a to pass through the second catalytic converter 2b and the third catalytic converter 2c of the second chamber 14 and the second chamber 15, and then converges and passes through the first direct-passage ceramic filter 3a and the second direct-passage ceramic filter 3b of the fourth chamber 16 to allow smog exhaust gas that contains carbon particles that have not been completely combusted in the engine and carbon monoxide and hydrocarbon, when discharged through an exhaust pipe, to be directly combusted and thus purified by the high temperatures of the first to third catalytic converters 2a, 2b, 2c at the front portion, while the remaining toxicant exhaust gas, such as nitrogen oxides (NOx), when passing through the first and second direct-passage ceramic filters 3a, 3b and the wall-flow filter 4 at the rear portion, can be decomposed and reduced by urea or ammonia back into nitrogen and water, so as to reduce pollution to the environment.

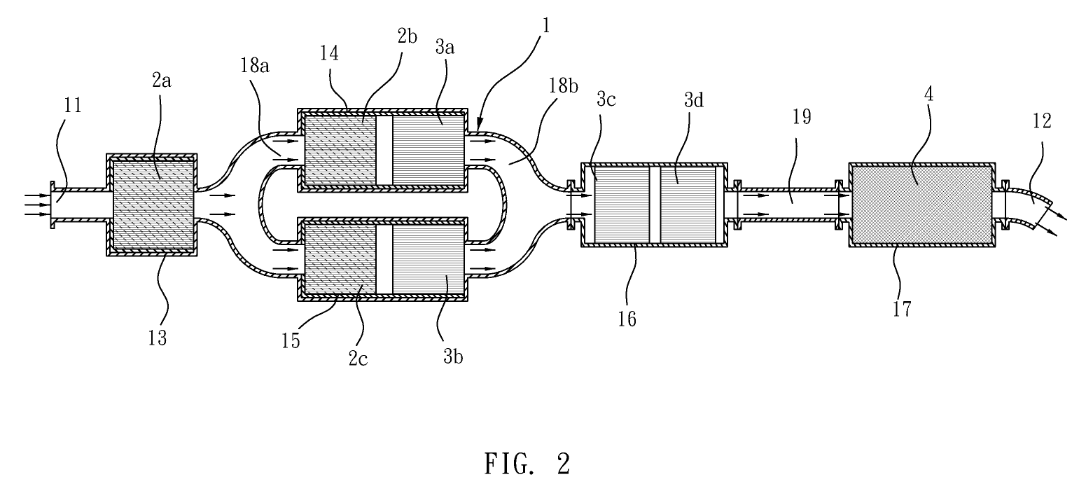

As shown in FIG. 2, the present invention provides a high-end processing device for purification of exhaust of a diesel engine, which comprises a connection channel 1, which comprises, mounted in sequence thereto, a first chamber 13, a second chamber 14, a third chamber 15, a fourth chamber 16, and a fifth chamber 17, wherein the second chamber 14 and the third chamber 15 are arranged parallel to each other and are connected, in a series manner, to the first chamber 13 by a Y-shaped first split passage 18a and also connected, in a series manner, to the fourth chamber 16 via a Y-shaped second split passage 18b; the fifth chamber 17 is connected, in a series manner, to the fourth chamber 16 via an elongate passage 19; the first chamber 13 has a leading end connected to an exhaust inlet 11; and the fifth chamber 17 has a tailing end connected to an exhaust outlet 12.

The first chamber 13 is provided therein with a first catalytic converter 2a. The second chamber 14 is provided therein with a second catalytic converter 2b and a first direct-passage ceramic filter 3a that are arranged in sequence in an axial direction. The third chamber 15 is provided therein with a third catalytic converter 2c and a second direct-passage ceramic filter 3b that are arranged in sequence in an axial direction. The fourth chamber 16 is provided therein with a third direct-passage ceramic filter 3c and a fourth direct-passage ceramic filter 3d that are arranged in sequence in an axial direction. The fifth chamber 17 is provided therein with a wall-flow filter 4. The operation is such that during a process that the exhaust gas discharged from a diesel engine enters, via the exhaust inlet 11 at one end of the connection channel 1, and drains out through the exhaust outlet 12 at an opposite end, exhaust gas first enters the first chamber 13 and fast passes through the first catalytic converter 2a, and then moves through the first split passage 18a to pass through the second catalytic converter 2b and the first direct-passage ceramic filter 3a contained in the second chamber 14 and the third catalytic converter 2c and the second direct-passage ceramic filter 3b contained in the third chamber 15, and then converges and passes through the third direct-passage ceramic filter 3c and the fourth direct-passage ceramic filter 3d of the fourth chamber 16 and the wall-flow filter 4 of the fifth chamber 17 to allow smog exhaust gas that contains carbon particles that have not been completely combusted in the engine and carbon monoxide and hydrocarbon, when discharged through an exhaust pipe, to be directly combusted and thus purified by the high temperatures of the first to third catalytic converters 2a, 2b, 2c at the front portion, while the remaining toxicant exhaust gas, such as nitrogen oxides (NOx), when passing through the first to fourth direct-passage ceramic filters 3a-3d and the wall-flow filter 4 at the rear portion, can be decomposed and reduced by urea or ammonia back into nitrogen and water, so as to reduce pollution to the environment.

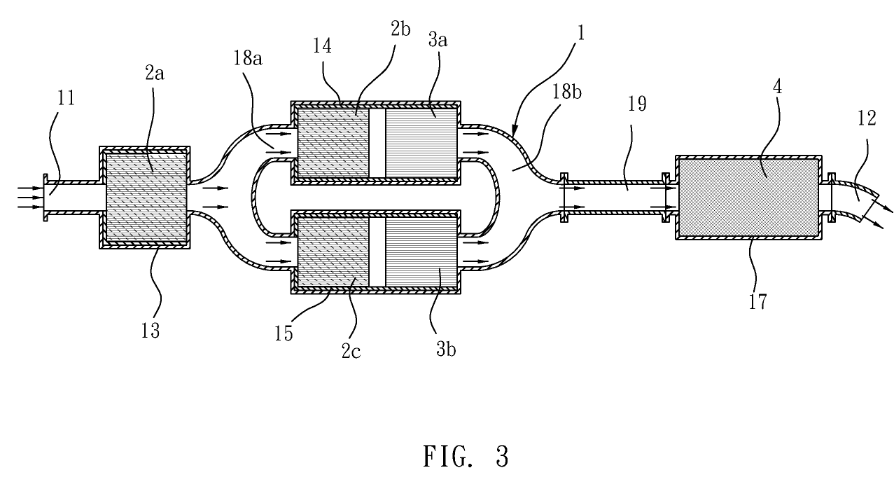

As shown in FIG. 3, the present invention provides a high-end processing device for purification of exhaust of a diesel engine, which comprises a connection channel 1, which comprises, mounted in sequence thereto, a first chamber 13, a second chamber 14, a third chamber 15, and a fourth chamber 16, wherein the second chamber 14 and the third chamber 15 are arranged parallel to each other and are connected, in a series manner, to the first chamber 13 by a Y-shaped first split passage 18a and also connected, in a series manner, to a straight passage 15 via a Y-shaped second split passage 18b and the straight passage 15 is connected, in series, to the fourth chamber 16; the first chamber 13 has a leading end connected to an exhaust inlet 11; and the fourth chamber 16 has a tailing end connected to an exhaust outlet 12.

The first chamber 13 is provided therein with a first catalytic converter 2a. The second chamber 14 is provided therein with a second catalytic converter 2b and a first direct-passage ceramic filter 3a that are arranged in sequence in an axial direction. The third chamber 15 is provided therein with a third catalytic converter 2c and a second direct-passage ceramic filter 3b that are arranged in sequence in an axial direction. The fourth chamber 16 is provided therein with a wall-flow filter 4. The operation is such that during a process that exhaust gas discharged from a diesel engine enters, via the exhaust inlet 11 at one end of the connection channel 1, and drains out through the exhaust outlet 12 at an opposite end, the exhaust gas first enters the first chamber 13 and fast passes through the first catalytic converter 2a, and then moves through the first split passage 18a to pass through the second catalytic converter 2b and the first direct-passage ceramic filter 3a contained in the second chamber 14 and the third catalytic converter 2c and the second direct-passage ceramic filter 3b contained in the third chamber 15, and then converges and passes through the wall-flow filter 4 of the fourth chamber 16 to allow smog exhaust gas that contains carbon particles that have not been completely combusted in the engine and carbon monoxide and hydrocarbon, when discharged through an exhaust pipe, to be directly combusted and thus purified by the high temperatures of the first to third catalytic converters 2a, 2b, 2c at the front portion, while the remaining toxicant exhaust gas, such as nitrogen oxides (NOx), when passing through the first and second direct-passage ceramic filters 3a, 3b and the wall-flow filter 4 at the rear portion, can be decomposed and reduced by urea or ammonia back into nitrogen and water, so as to reduce pollution to the environment.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A processing device for purification of exhaust of a diesel engine, comprising:
a connection channel, which comprises a plurality of chambers mounted thereto, at least one passage connecting between every two adjacent ones of the chambers so as to define an exhaust inlet and an exhaust outlet respectively located at opposite ends thereof;
a plurality of catalytic converters, which is respectively arranged in successive ones of the chamber posterior immediately to the exhaust inlet;
a plurality of direct-passage ceramic filters, which is respectively arranged in successive ones of the chambers that are posterior to one of the catalytic converters that is remote from the exhaust inlet; and
at least one wall-flow filter, which is arranged in one of the chambers that is posterior to one of the direct-passage ceramic filters that is remote from the exhaust inlet;
wherein the direct-passage ceramic filters and the wall-flow filter are first impregnated in a urea solution or an ammonia solution in advance to allow the urea solution or the ammonia solution to penetrate into pores of the direct-passage ceramic filters and the wall-flow filter and the dried so that the direct-passage ceramic filters and the wall-flow filter provide an effect of reducing nitrogen oxides back into nitrogen and water.

2. The processing device according to claim 1, which comprises a first chamber, a second chamber, a third chamber, a fourth chamber, and a fifth chamber that are arranged in sequence, the second chamber and the third chamber being arranged parallel to each other and being connected, in a series manner, to the first chamber and also being connected, in a series manner, to the fourth chamber, the fifth chamber being connected, in a series manner, to the fourth chamber, the first, second, and third chambers being respectively provided with a first catalytic converter, a second catalytic converter, and a third catalytic converter, the fourth chamber being provided with a first direct-passage ceramic filter and a second direct-passage ceramic filter that are arranged in sequence in an axial direction, the fifth chamber being provided with a wall-flow filter.

3. The processing device according to claim 1, which comprises a first chamber, a second chamber, a third chamber, a fourth chamber, and a fifth chamber that are arranged in sequence, the second chamber and the third chamber being arranged parallel to each other and being connected, in a series manner, to the first chamber and also being connected, in a series manner, to the fourth chamber, the fifth chamber being connected, in a series manner, to the fourth chamber, the first chamber being provided with a first catalytic converter, the second chamber being provided with a second catalytic converter and a first direct-passage ceramic filter that are arranged in sequence in an axial direction, the third chamber being provided with a third catalytic converter and a second direct-passage ceramic filter that are arranged in sequence in an axial direction, the fourth chamber being provided with a third direct-passage ceramic filter and a fourth direct-passage ceramic filter that are arranged in sequence in an axial direction, the fifth chamber being provided with a wall-flow filter.

4. The processing device according to claim 1, wherein comprises a first chamber, a second chamber, a third chamber and a fourth chamber that are arranged in sequence, the second chamber and the third chamber being arranged parallel to each other and being connected, in a series manner, to the first chamber and also being connected, in a series manner, to the fourth chamber, the first chamber being provided with a first catalytic converter, the second chamber being provided with a second catalytic converter and a first direct-passage ceramic filter that are arranged in sequence in an axial direction, the third chamber being provided with a third catalytic converter and a second direct-passage ceramic filter that are arranged in sequence in an axial direction, the fourth chamber being provided with a wall-flow filter.

5. The processing device according to claim 2, wherein the first chamber is connected via a first split passage to the second chamber and the third chamber and the second chamber and the third chamber are connected via a second split passage to the fourth chamber.

6. The processing device according to claim 3, wherein the first chamber is connected via a first split passage to the second chamber and the third chamber and the second chamber and the third chamber are connected via a second split passage to the fourth chamber.

7. The processing device according to claim 4, wherein the first chamber is connected via a first split passage to the second chamber and the third chamber and the second chamber and the third chamber are connected via a second split passage to the fourth chamber.

8. The processing device according to claim 2, wherein the fourth chamber and the fifth chamber are connected to each other by a straight passage.

9. The processing device according to claim 3, wherein the fourth chamber and the fifth chamber are connected to each other by a straight passage.

10. The processing device according to claim 4, wherein the second split passage is connected via a straight passage to the fourth chamber.

11. The processing device according to claim 2, wherein the fifth chamber comprises a firth direct-passage ceramic filter arranged therein to replace the wall-flow filter.
